(19) United States
(12) Patent Application Publication
(10) Pub. No.: US 2013/0163239 A1
(43) Pub. Date: Jun. 27, 2013

(54) MIXING OPTICAL ZOOM SYSTEM WITH MOVING GATE AND GOBO

(71) Applicants: Teunis Willem Tukker, Eindhoven (NL); Ralph Kurt, Eindhoven (NL)

(72) Inventors: Teunis Willem Tukker, Eindhoven (NL); Ralph Kurt, Eindhoven (NL)

(73) Assignee: KONINKLIJKE PHILIPS ELECTRONICS N.V., EINDHOVEN (NL)

(21) Appl. No.: 13/821,102

(22) PCT Filed: Sep. 6, 2011
(86) PCT No.: PCT/IB2011/053889

§ 371 Date: Mar. 6, 2013

(30) Foreign Application Priority Data
Sep. 10, 2010 (EP) 10176127.8

(51) Int. Cl. F21V 14/00

(52) U.S. Cl. CPC F21V 14/00
USPC 362/231; 362/277; 362/282; 362/268

(57) ABSTRACT

An illumination device (100) is disclosed. The illumination device (100) comprises a collimation module (110) configured to collimate light, a lens assembly (120) configured to controllably focus/defocus light, and an intermediate module (130) arranged between the collimation module (110) and the lens assembly (120) such as to receive collimated light output from the collimation module (110), wherein at least some light output from the intermediate module (130) impinges on the lens assembly (120).

### FIELD OF THE INVENTION

The present invention is generally related to lighting applications. In particular, the present invention relates to an illumination device.

### BACKGROUND OF THE INVENTION

In spot illumination applications, such as in entertainment lighting applications, in scene setting or other atmosphere creating lighting, colored light may be of importance. Examples of such applications are stage lighting, theatre lighting, studio lighting, architectural lighting (e.g., for city beautification), lighting in hotels, restaurants, etc. Colored light is often achieved by means of a combination of light sources emitting white light (also referred to as white light sources) and colored filters.

Lately, as an alternative, illumination systems with colored light sources, i.e. light sources emitting colored light, such as light emitting diodes (LEDs), have been developed. Thus, colored filters may not be required. In illumination systems with colored light sources, the color emitted by the illumination system may often be changed by means of electronic control within the range of colors available in the illumination system. LEDs intended for indication purposes have been used for a long time, but high-brightness LEDs, e.g. LEDs having a brightness that is high enough to enable general illumination of various locations such as mentioned above have in a short period of time caused a significant growth in the LED and lighting applications market. High brightness LEDs are generally associated with a small size, a relatively high efficacy (and associated low temperature), a relatively long lifetime, a wide color gamut and ease of control.

Particularly in stage lighting, there is often a need to create a controlled beam of light having sharp edges. This is often realized using a so called hard edge spot luminary (also called a profile lantern or an ellipsoidal profile spot). The hard edge spot luminary may comprise obstructions arranged in the optical path or axis, which obstructions can be projected onto a target surface by a lens or optics of the hard edge spot luminary. These obstructions may comprise shutters or a so called gobo, e.g., a piece of material with patterned holes through which light passes, which piece of material is placed in the beam of light such that only the desired ‘shape’ of light or pattern is passed through the piece of material, while the rest of the light is blocked, thereby achieving a specific shadow/light pattern in the illuminated plane. Often in the same application, there is additionally often a need or desire to create a wash beam, i.e. a beam of light having soft edges. This is often realized by bringing the lens or optics of the hard edge spot luminary out of focus, whereby soft edge effects can be provided. However, color mixing performance often deteriorates when the lens or optics of the hard edge spot luminary is brought out of focus, which may result in undesired color fringes in the shadow/light pattern projected onto the target surface, i.e. undesired fringes of color along boundaries separating bright and darker areas in the projected pattern.

### SUMMARY OF THE INVENTION

It is with respect to the above considerations and others that the present invention has been made. The present invention seeks to mitigate, alleviate or eliminate the above-mentioned disadvantage. In particular, it would be desirable to achieve an illumination device which enables projection of a shadow/light pattern onto a target surface. It would further be desirable with an illumination device that is capable both of providing a shadow/light pattern having sharp edges and providing a shadow/light pattern having soft edges, wherein the illumination device enables achieving a shadow/light pattern having soft edges while mitigating or even eliminating any undesired color fringes in the shadow/light pattern projected onto the target surface.

To achieve this, an illumination device having the features as defined in the independent claim is provided. Further advantageous embodiments of the present invention are defined in the dependent claims.

According to a first aspect of the present invention, there is provided an illumination device. The illumination device comprises a collimation module configured to collimate light, a lens assembly configured to controllably focus/defocus light, and an intermediate module arranged between the collimation module and the lens assembly such as to receive collimated light output from the collimation module, wherein at least some light that is output from the intermediate module impinges on the lens assembly. The intermediate module is adapted to alter the shape of at least a portion of the collimated light and/or be arranged with at least one optical element adapted to alter the shape of at least a portion of the collimated light. The illumination device comprises a positioning module configured to controllably move the intermediate module towards one of the collimation module and the lens assembly.

Thus, according to a first configuration the intermediate module itself is adapted to alter the shape of at least a portion of the collimated light.

According to a second configuration, the intermediate module is adapted to be arranged with at least one optical element adapted to alter the shape of at least a portion of the collimated light. In other words, the intermediate module may be arranged so as to be capable of receiving at least one optical element, which is adapted to alter the shape of at least a portion of the collimated light.

According to a third configuration, each of the intermediate module itself and at least one optical element that can be arranged in the intermediate module is adapted to alter the shape of at least a portion of the collimated light.

Each of these three configurations provide means for achieving an illumination device capable both of providing a shadow/light pattern having sharp edges and providing a shadow/light pattern having soft edges, while enabling mitigating or even eliminating any undesired color fringes in a shadow/light pattern having soft edges projected onto a target surface. This is achieved by means of the intermediate module itself being adapted to alter the shape of at least a portion of the collimated light and/or the intermediate module being arranged so as to be capable of receiving at least one optical element, which is adapted to alter the shape of at least a portion of the collimated light, and the positioning module configured to controllably move the intermediate module towards one of the collimation module and the lens assembly. Thus, the three configurations disclosed in the foregoing provide alternative advantageous solutions for achieving an illumination device capable of providing a shadow/light pattern.

In case where the intermediate module is adapted to be arranged with and/or adapted so as to be capable of receiving at least one optical element, the at least one optical element may be removably arranged.

In the context of the present application, by altering the shape of at least a portion of light it may be meant altering the light so as to block at least a portion of the light, hence transmitting only part of the light impinging on the intermediate module and/or optical element. This may be achieved, e.g., by means of an opaque material having holes and/or transmissive portions. The holes and/or transmissive portions may be arranged such that the illumination device is capable of projecting a predefined pattern of light/shadows onto a target surface.

Alternatively or optionally, in the context of the present application, by altering the shape of at least a portion of light it may be meant changing the wavelength of the at least a portion of light, and/or reflecting, refracting and/or diffracting the at least a portion of light.

The lens assembly may hence be configured to controllably focus and/or defocus light.

Thus, the present invention is based on an illumination device having a collimation module for collimating light, a lens assembly and an intermediate module arranged between the collimation module and the lens assembly, e.g., in a light path between the collimation module and the lens assembly. The collimated light is focused at a target surface by means of the lens assembly. The intermediate module comprises a beam-shaping element and/or is adapted to be arranged with a beam-shaping element, which may be removable. The intermediate module can be controllably moved towards one of the collimation module and the lens assembly.

The focus of the lens assembly with respect to the collimation module may be kept substantially constant at an illuminated plane on the target surface while the intermediate module is positioned in a focus between a light-emitting module in the illumination device and the lens assembly. By means of such a configuration, a controlled beam of light having sharp edges impinging on the target surface may be achieved.

When a beam of light having soft edges is required, the intermediate module may then be displaced from its position in a focus between the light-emitting module in the illumination device and the lens assembly, e.g., towards the lens assembly, by means of the positioning module. The focus of the lens assembly with respect to the collimation module may be substantially maintained or even completely maintained. This entails for example that, in case the light-emitting module is a multi-color light-emitting module and the collimation module has a color mixing capability, color mixing performance of the collimation module can remain substantially unchanged, since the focus of the lens assembly with respect to the collimation module is kept substantially constant or even constant. However, the intermediate module has been brought out of focus, which entails that the shaped beam emitted from the illumination device exhibits soft or blurred edges, as required. In this manner, a soft edge effect of a projected pattern of shadow/light can be achieved while any undesired color fringes in the shadow/light pattern projected onto the target surface may be mitigated or even eliminated.

By an illumination device according to the first aspect of the present invention, both a capability of providing a shadow/light pattern having sharp edges and a capability providing a shadow/light pattern having soft edges may be achieved by means of a single illumination device. Thus, separate devices for producing the respective effects may not be required.

As described in the foregoing, the illumination device may enable color mixing performance of the collimation module to remain substantially unchanged even when the intermediate module has been brought out of focus. Thus, a relatively good color mixing may be achieved in the illuminated plane. For example, a color mixing performance that is sufficient for the particular requirements of the application and/or situation may be achieved. The degree or performance of color mixing is hence dependent on the particular configuration of the collimation module or another color mixing means in the illumination device. Thus, by appropriately selecting and/or configuring the collimation module or another color mixing means, the color mixing performance may be tailored in accordance with user and/or application requirements.

It is contemplated that an illumination device according to the first aspect of the present invention is applicable to a range of applications, including but not limited to, entertainment lighting applications such as stage lighting, scene setting, or other atmosphere creating lighting applications.

The intermediate module may for example be arranged in an optical axis between the collimation module and the lens assembly.

The positioning module may be configured to controllably move the intermediate module in a direction parallel to the optical axis.

The positioning module may be configured to controllably move the intermediate module by a distance within a range of about 100 μm or greater.

The positioning module may be configured to controllably rotate the intermediate module about an axis parallel to the optical axis.

Hence, the intermediate module may be arranged to selectively and controllably rotate about an axis parallel to the optical axis. Such a configuration may enable an improved flexibility in configuring characteristics of light output by the illumination device, e.g., depending on the particular configuration of the intermediate module. In the case where the intermediate module comprises several parts, the entire intermediate module may be rotated or one or more of the parts of the intermediate module may be rotated individually.

The at least one optical element may comprise one or more of a gobo, a photo mask, a wavelength conversion element and a beam shaping element configured to reflect, refract and/or diffract light.

The intermediate module may comprise one or more of a gobo, a photo mask, a wavelength conversion element and a beam shaping element configured to reflect, refract and/or diffract light.

In the context of the present application, by the wording “photo mask” it is meant an element comprising holes or transparent portions that can be used to achieve light having a defined shape. The photo mask may for example comprise a substantially opaque plate-shaped element having holes or a plate-shaped element having opaque and transparent portions.

In the context of the present application, by the wording “gobo” it is meant a device arranged in an illumination device by which the shape of the light emitted by the illumination device and cast over a space or object can be manipulated so as to create a specific pattern of light and shadow in the illuminated plane.

The collimation module may comprise a tubular reflector with a reflective inner surface. The tubular reflector may have a light input aperture and a light output aperture, with the light output aperture being larger than the light input aperture. The reflective inner surface may be arranged to reflect and mix light.

Thus, the reflective inner surface may be arranged so as to enable reflection and mixing of light within the reflector, which light is then output from the tubular reflector, and possibly from the collimation module, via the light output aperture of the tubular reflector. Light from a multi-color light-emitting module can hence be color mixed in accordance with required color mixing performance requirements, depending on the specific configuration of the tubular reflector.

For example, at least a portion of the tubular reflector may comprise a polygonal cross section.

The polygonal cross section may for example be perpendicular to an optical axis extending between the light input aperture and the light output aperture.

By “polygonal cross section” it should, in the context of the present application, be understood a cross section that is bounded by a closed path of lines connected at at least three points, forming the corners of the polygonal cross section. The lines can be straight or curved. For example, each path between the corners of the polygon may be concave or convex with respect to the polygonal cross section. For example, the polygonal cross section may be septagonal (having seven sides) or enneagonal (having nine sides).

By the tubular reflector having any one of such cross sections as described immediately in the foregoing, a relatively high color mixing performance and/or efficiency may be attained.

According to another example, at least a portion of the tubular reflector may alternatively or optionally comprise a cross section having an essentially circular or elliptical shape.

Alternatively or optionally, the collimation module or the illumination device may comprise one or more of other suitable color mixing arrangements.

The tubular reflector may be shaped in such a way that a substantially Gaussian beam profile is achieved at the exit aperture or in the far field.

The illumination device may comprise at least one light-diffusing optical member arranged to diffuse light output by the illumination device. By such a configuration, homogeneity of the light output by the illumination device may be improved.

Such a light-diffusing optical member may be arranged adjacent in close proximity to a light output of the collimation module, e.g., adjacent or in proximity to the exit aperture of the tubular reflector. Alternatively or optionally, such a light-diffusing member may be arranged adjacent or in proximity to the intermediate module.

In general, light exiting the tubular reflector at the light output aperture may be better mixed close to the optical axis of the illumination device than it is further away from the optical axis. Therefore, the light-diffusing optical member may have a diffusing capability that depends on a distance from an optical axis of the illumination device. The diffusing capability may for example increase with increasing distance from the optical axis of the illumination device.

The illumination device may comprise at least one field lens or collimation lens arranged adjacent or in proximity to a light output of the collimation module, e.g., adjacent or in proximity to the exit aperture of the tubular reflector.

The lens assembly may comprise at least two lenses arranged in spaced relation to each other.

At least one lens of the lens assembly may be controllably moveable towards and/or away from another lens of the lens assembly and/or towards the intermediate module.

Such a lens assembly may enable varying its focal length. Hence, a zooming functionality of the illumination device may be achieved, e.g., a zoom lens may be achieved.

Hence, the lens assembly may be configured to controllably focus/defocus light emitted by the illumination device.

The lens assembly may comprise three or more lenses arranged in spaced relation to each other.

By such a configuration, a zoom lens that substantially can be maintained in focus independently of the value of the zoom factor (i.e. degree of zooming) or even be completely maintained in focus independently of the value of the zoom factor.

The depth of focus of a typical lens is about 100 μm.

Accordingly, the positioning module may be configured to controllably move the intermediate module into and/or out of a focus between the plurality of light sources and the lens assembly by a distance within a range of about 200 μm or greater, e.g., within a range of ±100 μm with respect to the focus between the plurality of light sources and the lens assembly.

The illumination device may comprise a plurality of light sources.

At least some of the plurality of light sources may be configured to, when activated, emit light into the collimation module.

The collimation module, the lens assembly and the intermediate module may be arranged in spaced relation to each other.

The positioning module may be configured to controllably move the intermediate module into and/or out of a focus between the plurality of light sources and the lens assembly.

The plurality of light sources may comprise at least one first set of light sources configured to emit light within a first wavelength range and at least one second set of light sources configured to emit light within at least a second wavelength range different from the first wavelength range.

In other words, the plurality of light sources may comprise at least one first set of light sources configured to emit light having a first color and at least one second set of light sources configured to emit light having a second color different from the first color.

At least one of the plurality of light sources may comprise a solid-state light source such as at least one light-emitting diode (LED). Such a LED may be inorganic or organic. The plurality of light sources may alternatively or optionally comprise one or more compact fluorescence lamps (CFL), high-intensity discharge (HID) lamps and/or halogen lamps. According to a second aspect of the present invention, there is provided an illumination system for spot illumination, which illumination system comprises an illumination device according to the first aspect of the present invention or any embodiment thereof.

According to a third aspect of the present invention, there is provided a method for operating an illumination device. The illumination device comprises a collimation module configured to collimate light, a lens assembly configured to controllably focus/defocus light, and an intermediate module arranged between the collimation module and the lens assembly such as to receive collimated light output from the collimation module. At least some light that is output from the intermediate module impinges on the lens assembly. The intermediate module is adapted to alter the shape of at least a portion of the collimated light and/or be arranged with at least one optical element adapted to alter the shape of at least a portion of the collimated light. The method comprises controllably moving the intermediate module towards one of the collimation module and the lens assembly. In case where the intermediate module is adapted to be arranged with and/or adapted so as to be capable of receiving at least one optical element, the at least one optical element may be removably arranged.

According to a fourth aspect of the present invention, there is provided a computer program product adapted to, when executed in a processor unit, perform a method according to an embodiment of the present invention.

According to a fifth aspect of the present invention, there is provided a computer-readable storage medium on which there is stored a computer program product adapted to, when executed in a processor unit, perform a method according to an embodiment of the present invention.

Such a processing unit, or microprocessor, may for example be comprised in an illumination device or an illumination system according to the first and second aspect of the present invention or an embodiment thereof, respectively. Alternatively or optionally, such processing unit or microprocessor may be arranged externally in relation to the illumination device or the illumination system, with the processing unit or microprocessor being electrically connected to the illumination device or the illumination system, respectively.

Examples of computer-readable storage mediums comprise a read only memory (ROM), a random access memory (RAM), a register, a cache memory, a semiconductor memory device, magnetic media such as an internal hard disk and/or a removable disk, magneto-optical media and optical media such as a CD-ROM disk and/or a Digital Versatile Disc (DVD).

Examples of suitable processing units comprise a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC) and/or a state machine.

The present invention relates to all possible combinations of features recited in the claims.

Further objects and advantages of the various embodiments of the present invention will be described below by means of exemplifying embodiments.

### BRIEF DESCRIPTION OF THE DRAWINGS

Exemplifying embodiments of the invention will be described below with reference to the accompanying drawings, in which:

FIG. 1 is a schematic exploded view of an illumination device according to an exemplifying embodiment of the present invention;

FIG. 2 is a schematic block diagram of an illumination device according to an exemplifying embodiment of the present invention;

FIG. 3 is a schematic block diagram of an illumination system according to an exemplifying embodiment of the present invention;

FIG. 4 is a schematic flow chart of a method according to an exemplifying embodiment of the present invention; and

FIG. 5 is a schematic view of a computer-readable digital storage medium according to an exemplifying embodiment of the present invention.

In the accompanying drawings, the same reference numerals denote the same or similar elements throughout the views.

### DETAILED DESCRIPTION

The present invention will now be described more fully hereinafter with reference to the accompanying drawings, in which exemplifying embodiments of the invention are shown. This invention may however be embodied in many different forms and should not be construed as limited to the embodiments set forth herein; rather, these embodiments are provided by way of example so that this disclosure will convey the scope of the invention to those skilled in the art. Furthermore, like numbers refer to like or similar elements throughout.

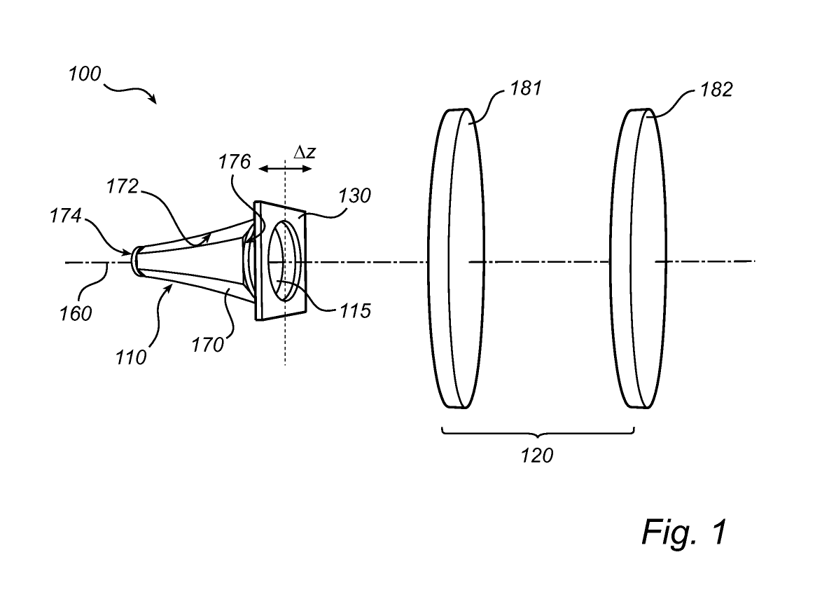

Referring now to FIG. 1, there is shown a schematic exploded view of an illumination device 100 according to an exemplifying embodiment of the present invention.

The illumination device comprises a collimation module 110, the collimation module 110 comprising a tubular reflector 170 having a reflective inner surface 172 adapted to reflect and mix light. As seen in FIG. 1, the tubular reflector may have a ‘trumpet’ shape. The tubular reflector has a light input aperture 174 and a light output aperture 176, where the light output aperture 176 is larger than the light input aperture 174.

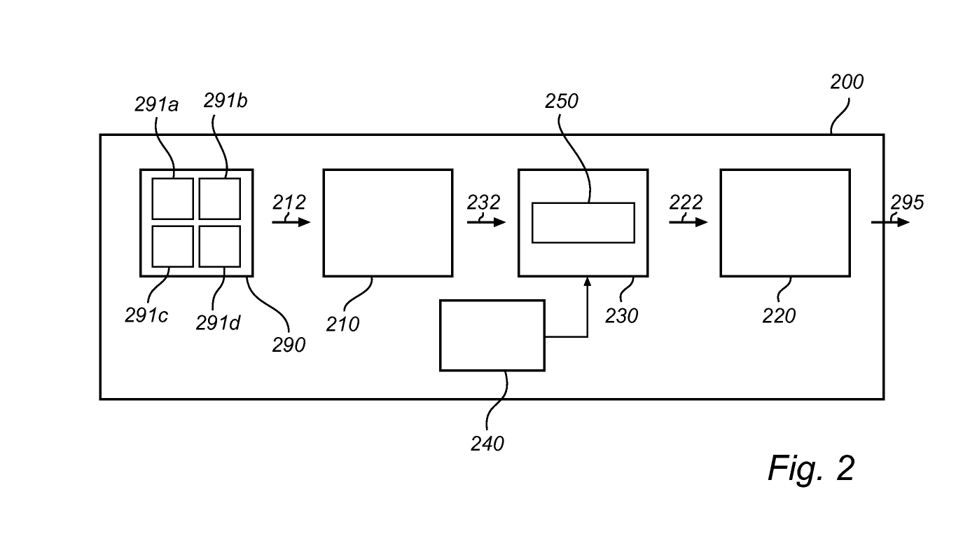

In the depicted embodiment, the collimation module 110 is configured to collimate and mix light input in the light input aperture 174. For example, the light input in the light input aperture 174 may be light emitted from a multi-color light-emitting module (not shown in FIG. 1, see FIG. 2), wherein the tubular reflector 170 is adapted to perform color mixing of the light input in the light input aperture 174.

The illumination device 100 comprises a lens assembly 120 and an intermediate module 130 positioned between the collimation module 110 and the lens assembly 120. The lens assembly 120 is configured to controllably focus/defocus light.

According to the embodiment depicted in FIG. 2, the lens assembly 120 comprises two lenses 181, 182. However, the present invention is not limited to a lens assembly comprising two lenses 181, 182, but the present invention encompasses embodiments comprising any number of lenses in the lens assembly, such as three, four, five, six lenses or more or even a single lens.

The illumination device 100 comprises a field lens or collimation lens 115 positioned between the intermediate module 130 and the light output aperture 176 of the collimation module's 110 tubular reflector 170.

As indicated in FIG. 1, the tubular reflector 170 is symmetric about the z-axis of the indicated coordinate system. According to the embodiment in FIG. 1, the z-axis coincides with the optical axis 160 of the illumination device 100, the optical axis 160 being indicated by the dashed line in FIG. 1.

As indicated in FIG. 1, the intermediate module 130 is movable towards one of the collimation module 110, or the field lens 115, and the lens assembly 120. Specifically, in accordance with the embodiment depicted in FIG. 1, the intermediate module 130 can be moved along the optical axis 160 within an interval Δz, which interval Δz is shown exaggerated relatively to the other components of the illumination device 100 in FIG. 1.

According to the embodiment depicted in FIG. 1, the intermediate module 130 is adapted to be arranged with an optical element (not shown in FIG. 1, see FIG. 2) adapted to alter the shape of at least a portion of the collimated light. The optical element may be removably arranged in the intermediate module 130.

The optical element may for example comprise one or more of a gobo, a photo mask, a wavelength conversion element and a beam-shaping element configured to reflect, refract, and/or diffract light.

The intermediate module 130 may comprise or constitute a holder for the optical element, which holder is movable along the optical axis 160.

Referring now to FIG. 2, there is shown a schematic block diagram of an illumination device 200 according to an exemplifying embodiment of the present invention.

The illumination device 200 comprises a light-emitting module 290 comprising a plurality of light sources 291a, 291b, 291c, 291d.

At least some of the plurality of light sources 291a, 291b, 291c, 291d are configured to, when activated, emit light 212 into a collimation module 210.

The plurality of light sources 291a, 291b, 291c, 291d may comprise at least one first set 291a, 291b, of light sources configured to emit light within a first wavelength range, and at least one second set 291c, 291d, of light sources configured to emit light within at least one second wavelength range, where the at least one second wavelength range is different from the first wavelength range.

For example, the light-emitting module 290 may comprise a light source array formed by light sources such as LEDs, mounted on a carrier, such as a printed circuit board (PCB) (not shown in FIG. 2). The PCB may be arranged on a heat spreader, which is in turn may be arranged on a heat sink (not shown in FIG. 2).

The illumination device 200 comprises an intermediate module 230 arranged such as to receive collimated light 232 output from the collimation module 210. At least some light 222 output from the intermediate module 230 impinges on a lens assembly 220 configured to controllably focus/defocus light.

The intermediate module 230 is arranged between the collimation module 210 and the lens assembly 220.

The illumination device 200 comprises a positioning module 240. The positioning module 240 is configured to controllably move the intermediate module 230 towards one of the collimation module 210 and the lens assembly 220.

The positioning module 240 may for example comprise mechanical means arranged to controllably move the intermediate module 230 towards one of the collimation module 210 and the lens assembly 220.

The intermediate module 230 may be adapted to alter the shape of at least a portion of collimated light or light input in the intermediate module 230.

Alternatively or optionally, according to the embodiment depicted in FIG. 2, the intermediate module 230 may be arranged with an optical element 250 adapted to alter the shape of at least a portion of collimated light or light input in the intermediate module 230.

In case where the intermediate module 230 is adapted to be arranged with and/or adapted so as to be capable of receiving at least one optical element 250, the at least one optical element 250 may be removably arranged in the intermediate module 230.

The optical element 250 may for example comprise one or more of a gobo, a photo mask, a wavelength conversion element and a beam-shaping element configured to reflect, refract, and/or diffract light.

The intermediate module 230 may comprise or constitute a holder for the optical element 250.

Light 295 output from the lens assembly 220 may then be emitted from the illumination device 200.

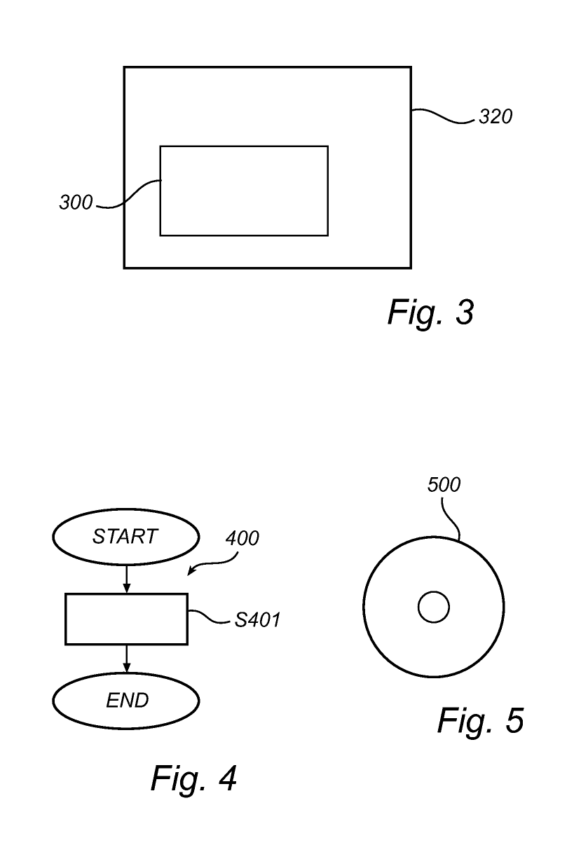

Referring now to FIG. 3, there is shown a schematic block diagram of an illumination system 320 according to an exemplifying embodiment of the present invention. The illumination system 320 comprises an illumination device 300 according to an embodiment of the present invention.

Referring now to FIG. 4, there is shown a schematic flowchart of a method 400 according to an exemplifying embodiment of the present invention.

The method 400 is a method of operating an illumination device comprising a collimation module configured to collimate light, a lens assembly configured to controllably focus/defocus light, and an intermediate module arranged between the collimation module and the lens assembly such as to receive collimated light output from the collimation module, wherein at least some light output from the intermediate module impinges on the lens assembly, the intermediate module being adapted to alter the shape of at least a portion of the collimated light and/or be arranged with at least one optical element adapted to alter the shape of at least a portion of the collimated light.

The method 400 comprises a step S401 comprising controllably moving the intermediate module towards one of the collimation module and the lens assembly.

Referring now to FIG. 5, there is shown a schematic view of a computer readable digital storage medium 500 according to an exemplifying embodiment of the present invention, comprising a Digital Versatile Disc (DVD) 500. On the DVD 500 there may be stored a computer program comprising computer code adapted to perform, when executed in a processor unit, a method according to the present invention or embodiments thereof.

Although only one type of computer-readable digital storage medium has been described above with reference to FIG. 5, the present invention encompasses embodiments employing any other suitable type of computer-readable digital storage medium, such as, but not limited to, a floppy disk, a non-volatile memory, a hard disk drive, a CD, a flash memory, magnetic tape, a USB stick, a Zip drive, etc., or any other suitable type of digital storage medium as described in the foregoing.

The illumination device or the illumination system may comprise one or more microprocessors (not shown) or some other device with computing capabilities, e.g. an application specific integrated circuit (ASIC), a field programmable gate array (FPGA), a complex programmable logic device (CPLD), etc., in order to perform operations as described herein.

When performing steps of different embodiments of the method of the present invention, the microprocessor typically executes appropriate software that is downloaded to the illumination device or the illumination system and stored in a suitable storage area, such as, e.g., a Random Access Memory (RAM) or a flash memory, or software that has been stored in a non-volatile memory, e.g., a Read Only Memory (ROM). Such a microprocessor or processing unit may alternatively or optionally be located externally relatively to the illumination device or the illumination system (and electrically connected to the illumination device or the illumination system, respectively).

In conclusion, there is provided an illumination device. The illumination device comprises a collimation module configured to collimate light, a lens assembly configured to controllably focus/defocus light, and an intermediate module arranged between the collimation module and the lens assembly such as to receive collimated light output from the collimation module, wherein at least some light output from the intermediate module impinges on the lens assembly.

Although exemplary embodiments of the present invention have been described herein, it should be apparent to those having ordinary skill in the art that a number of changes, modifications or alterations to the invention as described herein may be made. Thus, the above description of the various embodiments of the present invention and the accompanying drawings are to be regarded as non-limiting examples of the invention and the scope of protection is defined by the appended claims. Any reference signs in the claims should not be construed as limiting the scope.

1. An illumination device, comprising:
a multi-color light emitting module;
a collimation module configured to collimate light;
a lens assembly configured to controllably focus/defocus light;
an intermediate module arranged between the collimation module and the lens assembly such as to receive collimated light output from the collimation module, wherein at least some light output from the intermediate module impinges on the lens assembly; and
a positioning module configured to controllably move the intermediate module towards one of the collimation module and the lens assembly;
the intermediate module being adapted to either alter the shape of at least a portion of the collimated light; or be arranged with at least one optical element adapted to alter the shape of at least a portion of the collimated light, wherein said lens assembly is configured to maintain the focus substantially constant when the intermediate module is moved.

2. An illumination device according to claim 1, wherein the intermediate module is arranged in an optical axis between the collimation module and the lens assembly, wherein the positioning module is configured to controllably move the intermediate module in a direction parallel to the optical axis.

3. An illumination device according to claim 2, wherein the positioning module is further configured to controllably rotate the intermediate module about an axis parallel to the optical axis.

4. An illumination device according to claim 1, wherein the at least one optical element comprises one or more of a gobo, a photo mask, a wavelength conversion element and a beam shaping element configured to reflect, refract, absorb and/or diffract light.

5. An illumination device according to claim 1, wherein the intermediate module is selected from the group consisting of a gobo, a photo mask, a wavelength conversion element and a beam shaping element configured to reflect, refract, absorb and/or diffract light.

6. An illumination device according to claim 1, wherein the collimation module comprises a tubular reflector with a reflective inner surface, the tubular reflector having a light input aperture and a light output aperture, the light output aperture being larger than the light input aperture, the reflective inner surface being arranged to reflect and mix light.

7. An illumination device according to claim 6, wherein at least a portion of the tubular reflector comprises a polygonal cross section.

8. An illumination device according to claim 1, wherein the lens assembly comprises at least two lenses arranged in spaced relation to each other, wherein at least one lens of the lens assembly is controllably moveable towards and/or away from another lens of the lens assembly and/or towards the intermediate module.

9. An illumination device according to claim 1, further comprising a plurality of light sources, at least some of the plurality of light sources being configured to, when activated, emit light into the collimation module.

10. An illumination device according to claim 9, wherein the collimation module, the lens assembly and the intermediate module are arranged in spaced relation to each other, and the positioning module is configured to controllably move the intermediate module into and/or out of a focus between the plurality of light sources and the lens assembly.

11. An illumination device according to claim 9, wherein the plurality of light sources comprises at least one first set of light sources configured to emit light within a first wavelength range and at least one second set of light sources configured to emit light within at least one second wavelength range different from the first wavelength range.

12. An illumination system for spot illumination, comprising an illumination device (300) according to claim 1.

13. A method of operating an illumination device comprising a collimation module configured to collimate light, a lens assembly configured to controllably focus/defocus light, and an intermediate module arranged between the collimation module and the lens assembly such as to receive collimated light output from the collimation module, wherein at least some light output from the intermediate module impinges on the lens assembly, the intermediate module being adapted to alter the shape of at least a portion of the collimated light and/or be arranged with at least one optical element adapted to alter the shape of at least a portion of the collimated light, the method comprising:
controllably moving the intermediate module towards one of the collimation module and the lens assembly, while substantially maintaining the focus of the lens assembly with respect to the collimation module.

14-15. (canceled)
